(19) United States
(12) Patent Application Publication
(10) Pub. No.: US 2026/0034990 A1
(43) Pub. Date: Feb. 5, 2026

(54) DRIVING ASSISTANCE SYSTEM, DRIVING ASSISTANCE METHOD, AND STORAGE MEDIUM THEREOF

(71) Applicant: J-QuAD DYNAMICS Inc., Tokyo (JP)

(72) Inventors: YUKI YAMAMOTO, Tokyo (JP); RYU KAMBARA, Tokyo (JP); YUKA SATRE, Tokyo (JP); NOBUYUKI IMODA, Tokyo (JP)

(21) Appl. No.: 19/276,576

(22) Filed: Jul. 22, 2025

(30) Foreign Application Priority Data
Jul. 30, 2024 (JP) 2024-123719

(51) Int. Cl. B60W 30/18; B60K 35/28; B60W 50/14

(52) U.S. Cl. CPC B60W 30/18163; B60K 35/28; B60W 50/14; B60K 2360/171; B60K 2360/179; B60K 2360/1868; B60K 2360/779; B60W 2050/146; B60W 2554/4042; B60W 2554/4045; B60W 2554/4046; B60W 2554/802; B60W 2555/60

(57) ABSTRACT

A driving assistance system includes at least one processor with a memory storing computer program code. The at least one processor with the memory is configured to cause the driving assistance system to: schedule a lane change of the host vehicle; sense a deceleration of a target vehicle traveling on a rear side of the host vehicle in a target lane toward which the host vehicle plans to make the lane change; monitor a yielding behavior of the target vehicle when a deceleration of the target vehicle is sensed, the yielding behavior being a behavior in which the target vehicle yields an entry space of the target lane as a lane change destination to the host vehicle; and control an entry behavior of the host vehicle.

### CROSS REFERENCE TO RELATED APPLICATION

The present application claims the benefit of priority from Japanese Patent Application No. 2024-123719 filed on Jul. 30, 2024. The entire disclosure of the above application is incorporated herein by reference.

### TECHNICAL FIELD

The present disclosure relates to a driving assistance technology that assists driving of a host vehicle.

### BACKGROUND

There has been known a technology in which a lane change of a host vehicle is controlled in accordance with a speed of a following vehicle which is one of other road users. The lane change is a change of driving behavior made by the host vehicle.

### SUMMARY

According to an aspect of the present disclosure, a driving assistance system assists a driving of a host vehicle. The driving assistance system includes at least one processor with a memory storing computer program code. The at least one processor with the memory may be configured to cause the driving assistance system to schedule a lane change of the host vehicle, and sense a deceleration of a target vehicle traveling on a rear side of the host vehicle in a target lane. The target lane is a driving lane toward which the host vehicle plans to make the lane change. The at least one processor with the memory may be configured to monitor a yielding behavior of the target vehicle when a deceleration of the target vehicle is sensed. The yielding behavior is a behavior in which the target vehicle yields an entry space of the target lane as a lane change destination to the host vehicle. The at least one processor with the memory may be configured to control an entry behavior of the host vehicle. The entry behavior is a behavior in which the host vehicle moves to the entry space located on a front side of the target vehicle by which the yielding behavior is made.

### BRIEF DESCRIPTION OF DRAWINGS

Features of the present disclosure will become apparent from the following detailed description made with reference to the accompanying drawings. In the drawings:

FIG. 1 is a block diagram showing a physical configuration of a driving assistance system according to an embodiment of the present disclosure;

FIG. 2 is a schematic diagram showing a traveling environment of a host vehicle to which one embodiment is applied;

FIG. 3 is a block diagram showing a functional configuration of a driving assistance system according to an embodiment of the present disclosure;

FIG. 4 is a flowchart showing a driving assistance flow according to an embodiment of the present disclosure;

FIG. 5 is a schematic diagram for explaining a driving assistance flow according to an embodiment of the present disclosure;

FIG. 6 is a schematic diagram for explaining a driving assistance flow according to an embodiment of the present disclosure;

FIG. 7 is a schematic diagram for explaining a driving assistance flow according to an embodiment of the present disclosure;

FIG. 8 is a schematic diagram for explaining a driving assistance flow according to an embodiment of the present disclosure; and

FIG. 9 is a schematic diagram for explaining a driving assistance flow according to an embodiment of the present disclosure.

### DETAILED DESCRIPTION

In a related art, the following vehicle traveling on a rear side in the same driving lane as the host vehicle is set as a target that serves as the criterion for determining whether to make a lane change of the host vehicle. However, in order to quickly determine whether to make a lane change thereby ensuring a safety of the host vehicle, a relative relationship with other vehicles traveling in a target driving lane toward which the host vehicle plans to make the lane change is very important. With the technology disclosed in the related art, there is a concern that unexpected interaction may occur between the host vehicle and the target vehicle traveling in the target driving lane, and this may affect the safety and security of the host vehicle when making the lane change.

According to a first aspect of the present disclosure, a driving assistance system assists a driving of a host vehicle. The driving assistance system includes at least one processor with a memory storing computer program code. The at least one processor with the memory may be configured to cause the driving assistance system to schedule a lane change of the host vehicle, and sense a deceleration of a target vehicle traveling on a rear side of the host vehicle in a target lane. The target lane is a driving lane toward which the host vehicle plans to make the lane change. The at least one processor with the memory may be configured to monitor a yielding behavior of the target vehicle when a deceleration of the target vehicle is sensed. The yielding behavior is a behavior in which the target vehicle yields an entry space of the target lane as a lane change destination to the host vehicle. The at least one processor with the memory may be configured to control an entry behavior of the host vehicle. The entry behavior is a behavior in which the host vehicle moves to the entry space located on a front side of the target vehicle by which the yielding behavior is made.

According to a second aspect of the present disclosure, a driving assistance method is executed by at least one processor to assist a driving of a host vehicle. The driving assistance method includes: scheduling a lane change of the host vehicle; sensing a deceleration of a target vehicle traveling on a rear side of the host vehicle in a target lane, the target lane being a driving lane toward which the host vehicle plans to make the lane change; monitoring a yielding behavior of the target vehicle when a deceleration of the target vehicle is sensed, the yielding behavior being a behavior in which the target vehicle yields an entry space of the target lane as a lane change destination to the host vehicle; and controlling an entry behavior of the host vehicle, the entry behavior being a behavior in which the host vehicle moves to the entry space located on a front side of the target vehicle by which the yielding behavior is made.

According to a third aspect of the present disclosure, a computer-readable non-transitory storage medium stores a driving assistance program for assisting a driving of a host vehicle. The driving assistance program includes instructions for causing at least one processor to: schedule a lane change of the host vehicle; sense a deceleration of a target vehicle traveling on a rear side of the host vehicle in a target lane, the target lane being a driving lane toward which the host vehicle plans to make the lane change; monitor a yielding behavior of the target vehicle when a deceleration of the target vehicle is sensed, the yielding behavior being a behavior in which the target vehicle yields an entry space of the target lane as a lane change destination to the host vehicle; and control an entry behavior of the host vehicle, the entry behavior being a behavior in which the host vehicle moves to the entry space located on a front side of the target vehicle by which the yielding behavior is made.

In the above-described first to third aspects of the present disclosure, the deceleration of the target vehicle traveling on the rear side of the host vehicle in the target lane is sensed. The target lane is a driving lane toward which the host vehicle is scheduled to make the lane change. Then, the target vehicle, whose deceleration is sensed, is monitored whether the yielding behavior is made by the target vehicle in the target lane. The yielding behavior is a behavior in which the target vehicle yields the entry space to the host vehicle as the lane change destination. This configuration enables an early detection of the target vehicle, which has made a decelerated in the target lane and intends to yield the entrance space of the target lane to the host vehicle. Therefore, in a case where the entry behavior of host vehicle is to be controlled for the entry space, which is located on front side of the target vehicle, and the yielding behavior of target vehicle has been confirmed, it is possible to ensure safety and security between the host vehicle and the target vehicle traveling in the target lane.

The following will describe an embodiment of the present disclosure with reference to the accompanying drawings.

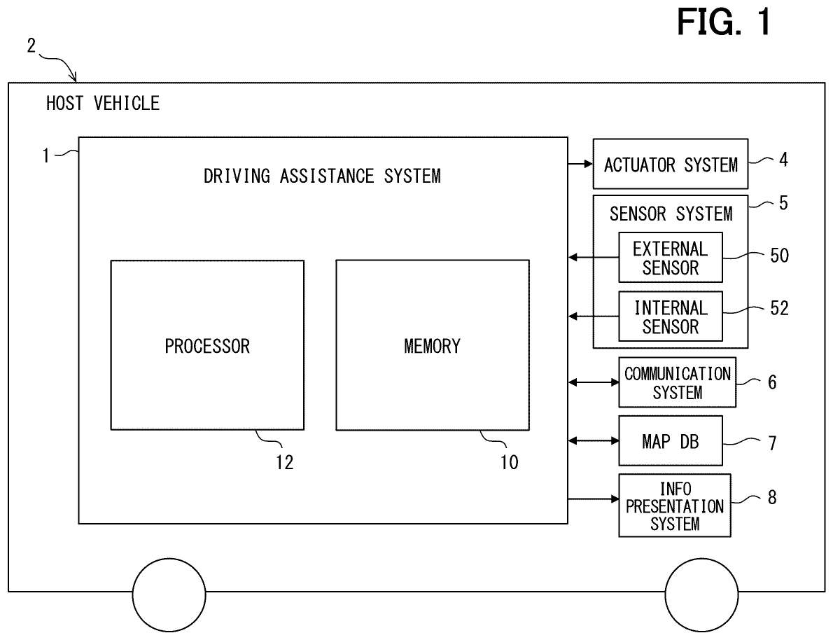

A driving assistance system 1 according to one embodiment of the present disclosure is shown in FIG. 1. The driving assistance system 1 assists a driving operation of a host vehicle 2. At least a part of the driving assistance system 1 is installed in the host vehicle 2. The host vehicle 2 to which the driving assistance system 1 is applied is capable of achieving a level of automated driving defined, for example, in SAE J3016. In SAE J3016, in addition to automated driving tasks, manual driving assistance tasks that assist the operator in manual driving operations are also defined.

The host vehicle 2 is a road user, such as an automobile or a truck, and may be referred to as an ego vehicle. In the present embodiment, an occupant who is seated in a seat inside the host vehicle 2 and is able to perform a manual driving operation is also referred to as a host occupant, and corresponds to a target of the driving assistance provided by the driving assistance system 1.

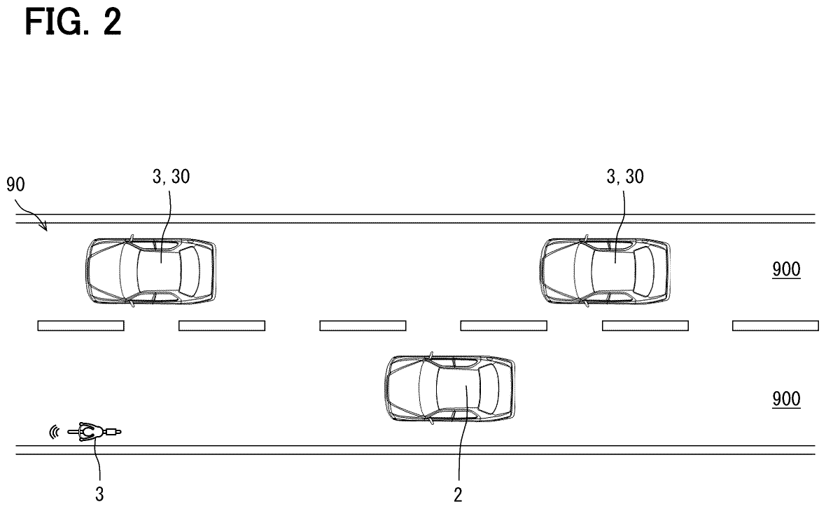

As shown in FIG. 2, in a driving environment of the host vehicle 2, a traffic scene may include other road users 3 in addition to the host vehicle 2. The other road users 3 include vulnerable road users and non-vulnerable road users. The vulnerable road users and the non-vulnerable road users are defined according to the vulnerability. A vulnerable user may be a human being, such as a pedestrian. A non-vulnerable road user may be at least one type of a mobile vehicle with human occupants, such as, automobiles, trucks, buses, motorcycles, and bicycles. Among these non-vulnerable road users, vehicles capable of automated driving by using a power source equipped thereto, such as automobiles, trucks, buses, and motorcycles, are subject to monitoring by the driving assistance system 1 as target vehicles 30.

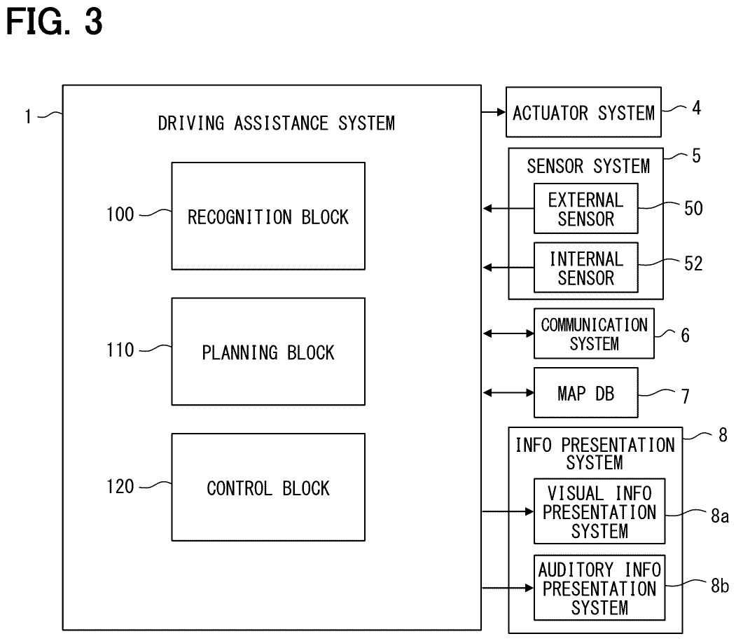

As shown in FIG. 1 and FIG. 3, the host vehicle 2 is equipped with an actuator system 4, a sensor system 5, a communication system 6, a map database (DB) 7, and an information presentation system 8 together with at least a part of the driving assistance system 1. FIG. 1 representatively shows an example in which the entire part of driving assistance system 1 is implemented in the form of a driving assistance device mounted on the host vehicle 2. The driving assistance device may be implemented by a control device (for example, a control ECU) or a semiconductor device (for example, a semiconductor chip).

The actuator system 4 shown in FIG. 1 and FIG. 3 is configured to be able to control the host vehicle 2 based on a control command output from the driving assistance system 1. The actuator system 4 may be at least one type of power train actuator of, for example, an internal combustion engine, a motor generator motor, or the like. The actuator system 4 may be at least one type of brake actuator of, for example, a brake unit or the like. The actuator system 4 may be at least one type of steering actuator of, for example, a power steering unit or the like. The actuator system 4 may be at least one type of light emitting actuator, such as a headlight unit, a hazard unit, or a direction indicator.

The sensor system 5 senses external and internal environments of the host vehicle 2 to obtain sensing information that can be used in the driving assistance system 1. For this purpose, the sensor system 5 includes an external sensor 50 and an internal sensor 52.

The external sensor 50 senses targets existing in the external environment of the host vehicle 2. The external sensor 50 of target sensing type is at least one of a vehicle-mounted camera, a LiDAR (light detection and ranging/laser imaging detection and ranging), a laser sensor, a millimeter wave sensor, a sonar sensor, or the like. The external sensor 50 of target sensing type may be implemented in a combined manner by combining different types of sensors so as to be capable of sensing front direction, lateral direction, and rear direction of the host vehicle 2.

The internal sensor 52 senses a specific physical quantity of motion related to vehicle motion in the internal environment of the host vehicle 2. The internal sensor 52 of motion sensing type is at least one of a speed sensor, an acceleration sensor, a gyro sensor, an inertial sensor, or the like. The internal sensor 52 may sense the operations or states of the occupants that include the driver in the internal environment of the host vehicle 2. The internal sensor 52 of occupant sensing type may be at least one of an accelerator pedal sensor, a brake pedal sensor, a shift sensor, a steering angle sensor, a steering torque sensor, an occupant camera, an occupant seat switch, a gesture sensor, a biometric sensor, or a seating sensor.

The communication system 6 acquires communication information to be used in the driving assistance system 1 via a communication network. The communication system 6 may receive a positioning signal from an artificial satellite of a global navigation satellite system (GNSS) existing in the outside of the host vehicle 2. The communication system 6 of positioning type is, for example, a GNSS receiver or the like. The communication system 6 may transmit and receive a communication signal to and from a vehicle to everything (V2X) system located outside of the host vehicle 2. The communication system 6 of V2X communication type is at least one of, for example, a dedicated short range communications (DSRC) communication device, a cellular V2X (C-V2X) communication device, or the like. The communication system 6 may transmit and receive communication signals to and from a mobile terminal existing in the internal environment of the host vehicle 2. The communication system 6 of terminal communication type is at least one of, for example, Bluetooth (registered trademark) device, Wi-Fi (registered trademark) device, infrared communication device, or the like.

The map DB 7 stores map information that can be used in the driving assistance system 1. The map DB 7 is implemented by at least one of a non-transitory tangible storage medium, such as a semiconductor memory, a magnetic medium, an optical medium, or the like. The map DB 7 may be a DB of a locator that estimates a self-position of the host vehicle 2. The map DB may be a DB of navigation unit that navigates a travel route of the host vehicle 2. The map DB 7 may be constructed by a combination of multiple types of DBs.

The map DB 7 downloads digital maps as necessary, for example, by performing via V2X communication with an external center via the communication system 6, and updates the map information. The map information is converted into two-dimensional or three-dimensional data as information representing the external environment in which the host vehicle 2 is traveling. As the three-dimensional map information, digital data of a high-precision map may be adopted. The map information includes road information that indicates at least one of locations, shapes, sizes of the road. The map information may include structure information that indicates at least one of positions, shapes, and sizes of buildings and traffic lights facing the road. The map information may include road marking information that indicates at least one of positions, shapes, sizes of signs and road markings of the road.

The information presentation system 8 presents notification information to an occupant of the host vehicle 2. The information presentation system 8 presents notification information to the occupant of the host vehicle 2 by stimulating a visual sense of the occupant. The information presentation system 8 of visual type (hereinafter referred to as visual information presentation system 8a as shown in FIG. 3) is at least one of an electronic mirror unit, a monitor unit, a navigation unit, a HUD (head-up display) unit, an illumination unit, or the like. The information presentation system 8 may present the notification information by stimulating auditory sense of the occupant. The information presentation system 8 of auditory information presentation type (hereinafter, referred to as auditory information presentation system 8b as shown in FIG. 3) is at least one of a speaker, a buzzer, a vibration unit, or the like.

The driving assistance system 1 is connected to the actuator system 4, the sensor system 5, the communication system 6, the map DB 7, and the information presentation system 8 via at least one type of, for example, a local area network (LAN), a wire harness, an internal bus, a wireless communication line, or the like. The driving assistance system 1 is implemented by at least one dedicated computer.

The dedicated computer constituting the driving assistance system 1 may be an integrated Electronic Control Unit (ECU) that integrally controls the driving of the host vehicle 2. The dedicated computer constituting the driving assistance system 1 may be a sensing ECU that processes sensing information in driving control of the host vehicle 2. The dedicated computer constituting the driving assistance system 1 may be a recognition ECU that recognizes the external environment in driving control of the host vehicle 2. The dedicated computer constituting the driving assistance system 1 may be a locator ECU that estimates the self-position of the host vehicle 2.

The dedicated computer constituting the driving assistance system 1 may be a planning ECU that plans the driving control of the host vehicle 2. The dedicated computer constituting the driving assistance system 1 may be a navigation ECU that navigates a traveling route in driving control of the host vehicle 2. The dedicated computer constituting the driving assistance system 1 may be an actuator ECU that controls the actuator system 4 as part of driving control of the host vehicle 2.

The dedicated computer constituting the driving assistance system 1 may be an information management ECU that controls the information presentation system 8 as part of driving control of the host vehicle 2. The dedicated computer constituting the driving assistance system 1 may be at least one external computer that constructs an external center or a mobile terminal which is able to perform communication via the communication system 6.

The dedicated computer constituting the driving assistance system 1 has at least one memory 10 and at least one processor 12 as shown in FIG. 1. The memory 10 is provided by a computer-readable non-transitory tangible storage medium, such as a semiconductor memory, a magnetic medium, or an optical medium, and stores computer-readable program and data. The processor 12 includes, as a core, at least one type of, for example, a central processing unit (CPU), a graphics processing unit (GPU), a reduced instruction set computer (RISC)-CPU, or the like.

The processor 12 executes multiple instructions included in a processing program stored in the memory 10 as software. As a result, the driving assistance system 1 constructs multiple functional blocks for assisting the driving of the host vehicle 2. The multiple functional blocks constructed by the driving assistance system 1 include a recognition block 100, a planning block 110, and a control block 120, as shown in FIG. 3.

The recognition block 100 acquires sensing information from the sensor system 5. The recognition block 100 acquires communication information from the communication system 6. The recognition block 100 acquires map information stored in the map DB 7. The recognition block 100 acquires, from the memory 10, history data of control commands given by the control block 120 to the host vehicle 2. The recognition block 100 processes the acquired information and data individually and then fuses them to recognize the state of the external and internal environments for each driving scene of the host vehicle 2 and generate recognition data.

Specifically, the recognition block 100 generates recognition data by localization that recognizes the self-status including the self-position of the host vehicle 2. The recognition data related to the status of host vehicle may represent at least one of the following data of the host vehicle 2 in accordance with the control commands from the control block 120: own position (longitude, latitude, and altitude), orientation angle, steering angle, speed, acceleration, jerk, and yaw rate.

The recognition block 100 generates recognition data by recognizing targets existing in the external environment of the host vehicle 2. The targets include other road users 3, obstacles, and structures. The recognition data related to the target in the present embodiment is generated so as to include sensing recognition information related to a target vehicle 30 and an occupant of the target vehicle 30. The target vehicle and occupant thereof are recognized by sensing operation of the external sensor 50 equipped to the host vehicle 2. The recognition data related to the target may represent at least one of physical quantity of motion, such as a distance, a direction of motion, a relative speed, a relative acceleration, and a time to collision. The recognition data related to the target may represent classifications of the target clustered based on such physical quantities of motion.

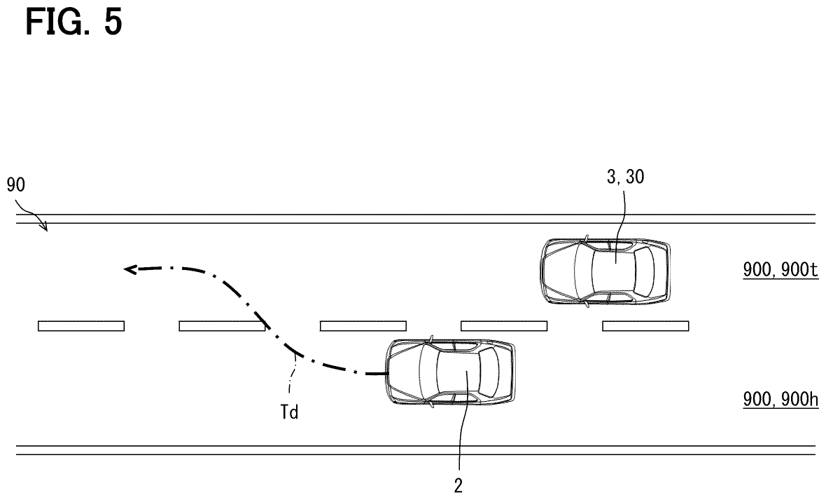

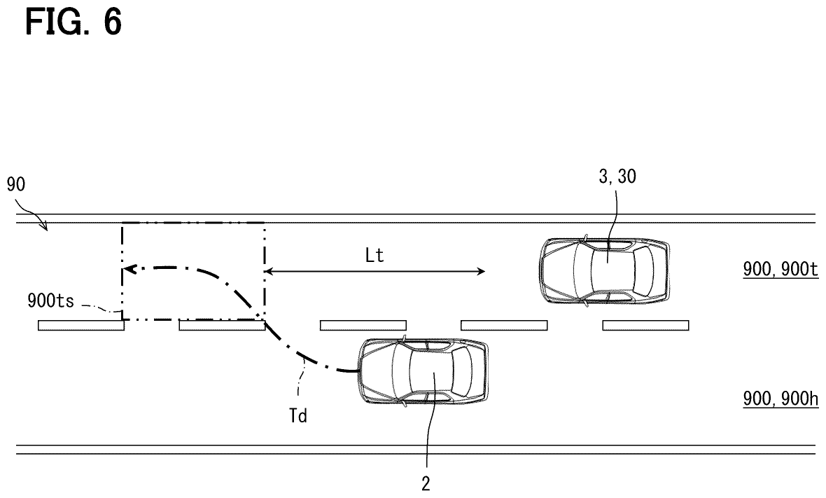

The recognition block 100 generates recognition data by recognizing the road on which the host vehicle 2 is traveling. The recognition data related to road may represent at least a type of the road structure. The recognition data related to road may represent at least one type of road structure, such as the number, location, width, length, shape, curve curvature, curve radius, and nodes of a driving lane 900 (see FIG. 2, FIG. 5, and FIG. 6) that constitutes a driving path 90 of the general road on which the host vehicle 2 and the target vehicle 30 are traveling.

The recognition block 100 generates the recognition data by recognizing road markings associated with the road on which the host vehicle 2 is traveling. The recognition data related to road markings may represent at least one type of marking state among road signs, boundary lines, and traffic lights. The recognition data related to road markings may further represent at least one of the following traffic rules recognized from the state of the markings: direction of travel, speed limit, and stopping positions. For these reasons, the recognition data related to the driving path 90 of general road (see FIG. 2, FIG. 5, and FIG. 6) may include identification data for identifying the driving lanes 900 in which the host vehicle 2 and the target vehicle 30 are traveling, respectively.

The recognition block 100 may generate the recognition data by recognizing an operation made by the driver, who corresponds to an operator, with respect to the host vehicle 2. The recognition data related to the driver operation, which gives a manual driving assistance task to the host vehicle 2, may represent at least one type of the following type information: accelerator pedal operation amount; brake pedal operation amount; shift position; steering angle; and steering torque; or the like. The recognition data related to the driver operation to switch the driving task performed to the host vehicle 2 between automated driving task and manual driving assistance task may represent the operation state of at least one of passenger seat switch, such as a task switching switch and an assist switch.

The planning block 110 obtains the recognition data from the recognition block 100. The planning block 110 acquires history data of control commands to the host vehicle 2 by reading the history data from the memory 10. Based on the acquired data, the planning block 110 plans a target driving trajectory Td (see FIG. 5 and FIG. 6) for the future travel of the host vehicle 2.

The driving trajectory Td specifies the time-based changes in the motion parameters targeted as the self-status of the host vehicle 2 for each control period assumed in the future with respect to the current time. The driving trajectory Td may represent the position coordinates of the path that the host vehicle 2 is to follow in the future for each control period. The driving trajectory Td may represent at least one type of physical quantity of motion, such as speed, acceleration, jerk, yaw rate, and yaw angle, as a motion parameter to be generated for each control period on the driving trajectory.

The control block 120 obtains the recognition data from the recognition block 100. The control block 120 obtains data of the driving trajectory Td from the planning block 110. The control block 120 acquires the history data of control commands output to the host vehicle 2 by reading the history data from the memory 10. The control block 120 generates control commands for the host vehicle 2 based on the acquired data. At this time, a control command to be output to the actuator system 4 is generated so as to control a driving behavior in accordance with the driving automation level. The driving automation level is adjusted according to the driving scene, among the autonomous driving tasks and manual driving assistance tasks of the host vehicle 2. The generated control command data is stored in the memory 10.

The control example of driving behavior according to the level of driving automation includes lane change assist, lane keeping assist, adaptive cruise control, and collision mitigation braking. The adjustment of driving automation level may include a takeover of the driving task between the driving assistance system 1 and the driver by switching the driving mode between an autonomous driving task and a manual driving assistance task. Such a handover may be performed at least at one of the following times: a time when takeover request is made by the driver; a time when entering or leaving the operational design domain (ODD) of the automated driving; and a time when a minimum risk manoeuvre (MRM) is required.

### (Driving Assistance Flow)

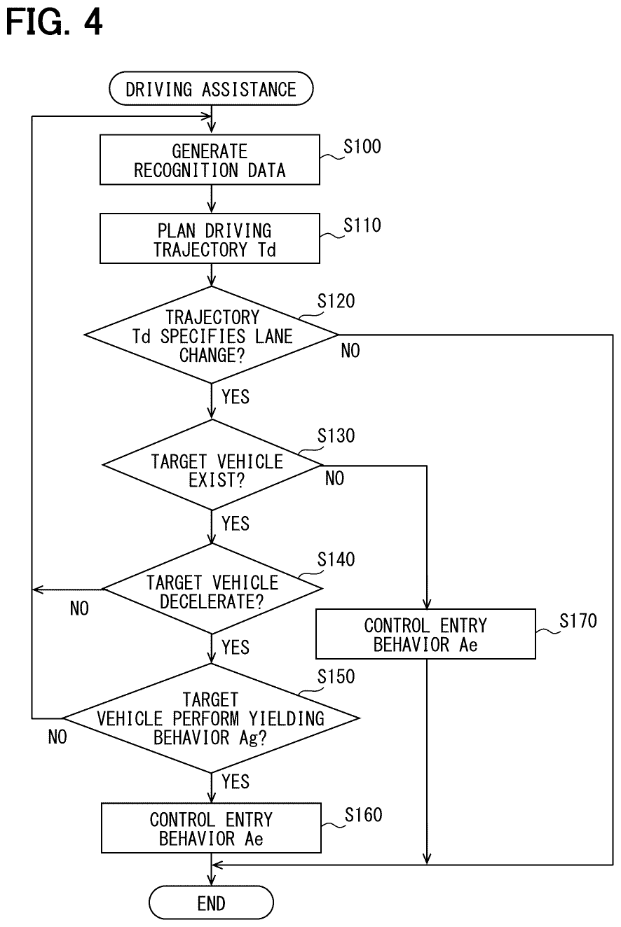

By cooperation of the blocks 100, 110, and 120 described above, the driving assistance method by which the driving assistance system 1 assists the driving of the host vehicle 2 is repeatedly executed in accordance with the driving assistance flow shown in FIG. 4 during traveling of the host vehicle 2. In the following description, each “S” in the driving assistance flow represents a step executed by an instruction included in the driving assistance program.

In S100, the recognition block 100 generates recognition data that recognizes the status of the external and internal environments in the current driving scene of the host vehicle 2. In S110, the planning block 110 plans a driving trajectory Td of the host vehicle 2 for future driving from the current driving scene based on the recognition data generated by at least in S100 of the current flow out of the data generated in current flow and the past flow. The recognition data generated in S100 may be updated as necessary in S120 and thereafter, which will be described later.

In S120, the control block 120 determines whether the driving trajectory Td planned in S110 of the current flow specifies a lane change of the host vehicle 2. In this case, lane change refers to a driving task in which the host vehicle 2 moves from the host lane 900h, which is the driving lane 900 in which the host vehicle 2 is currently traveling, to another driving lane 900 of a driving path 90 on which multiple driving lanes 900 are defined in parallel, as shown in FIG. 5. The driving trajectory Td that specifies the lane change may be planned to control the switch from a manual driving assistance task, for example, by operating a task switching switch or an assist switch, to an automatic lane change as an automatic driving task. The driving trajectory Td defining the lane change may be planned to control switching to an automatic lane change as an automated driving task during execution.

As shown in FIG. 4, when a negative determination is made in S120, the current flow ends. In S120, when a positive determination is made, the current flow proceeds to S130. In S130, the recognition block 100 determines whether a target vehicle 30 exists, which is predicted to interact with the host vehicle 2 in response to the lane change determined in S120 of the current flow, based on the recognition data including the sensing recognition information.

In S130, the flow determines whether a target vehicle 30 traveling in the same direction as the host vehicle 2 exists in the target lane 900t, which is the lane change destination of the host vehicle among the driving lanes 900 that are adjacent to and parallel to the host lane 900h, as shown in FIG. 5. At this time, the flow may determine whether the target vehicle 30 exists on the target lane 900t within a set distance range from the host vehicle 2 set within the sensing area of the external sensor 50.

As shown in FIG. 4, when a positive determination is made in S130, the current flow proceeds to S140. In S140, the recognition block 100 determines whether the target vehicle 30 confirmed in S130 of the current flow has decelerated based on the recognition data including the sensing recognition information. The determination process in S140 is equivalent to determining whether deceleration of the target vehicle 30 has been sensed.

When a negative determination is made in S140, the current flow returns to S100. When a positive determination is made in S140, the current flow proceeds to S150. In S150, the recognition block 100 monitors whether a yielding behavior Ag is made by the target vehicle 30, whose deceleration has been sensed in S140 of the current flow, such that the target vehicle 30 yields the target lane 900t to the host vehicle 2. The yielding behavior Ag at this time is performed to convey the intention of the target vehicle 30, which has decelerated on the target lane 900t, to secure an entry space 900ts, toward which the host vehicle 2 is going to move for lane change, with a distance of at least Lt being secured between the target vehicle 30 and the host vehicle 2, as shown in FIG. 6.

In S150, a direct notification of yielding behavior Ag from the target vehicle 30 whose deceleration has been sensed may be monitored based on recognition data including sensing recognition information and/or communication information. In this case, the notification of the yielding behavior Ag may be a headlight flashing of the target vehicle 30. The notification of the yielding behavior Ag may be a flashing of the hazard lights of the target vehicle 30. The notification of the yielding behavior Ag may be a blinking of the direction indicator of the target vehicle 30, which is arranged close to the host lane 900h. The notification of the yielding behavior Ag may be switching between the headlights and the position lights of the target vehicle 30. The notification of the yielding behavior Ag may be a sound output from a horn or a sound output from a speaker in the target vehicle 30. The notification of the yielding behavior Ag may be an output of communication information transmitted from the target vehicle 30 through a communication network.

In S150, an indirect expression of intention to perform the yielding behavior Ag by a target occupant, who is an occupant of the target vehicle 30 whose deceleration has been sensed, may be monitored based on recognition data including sensing recognition information. The intention of the yielding behavior Ag is expressed by at least one of the following actions related to the target occupant: facial expression, head movement, and hand gestures. In S150, a direct yielding behavior Ag in which the target vehicle 30, whose deceleration has been sensed, travels slower than the legal speed limit of the target lane 900t may be monitored based on recognition data including sensing recognition information and sigh information.

In S150, when a negative determination is made because the yielding behavior Ag of the target vehicle 30 is not confirmed within the set duration, the current flow returns to S100. In S150, when a positive determination is made because the yielding behavior Ag of the target vehicle 30 is confirmed within the set duration, the current flow proceeds to S160. In S160, the control block 120 controls the host vehicle 2 to perform an entry behavior Ae into the entry space 900ts ahead of the target vehicle 30 whose yielding behavior Ag has been confirmed in S150 of the current flow.

In S160, in response to the entry behavior Ae, the control block 120 may execute notification control to notify the host occupant in the host vehicle 2 of the start of the entry behavior Ae in a manner recognizable by the host occupant. The auditory information presentation system 8b may be controlled to notify the start of entry behavior Ae by audio output or pronunciation. The start of entry behavior Ae may be notified by controlling the visual information presentation system 8a to display an image that allows the host occupant to recognize the start position or start timing of the entry behavior Ae.

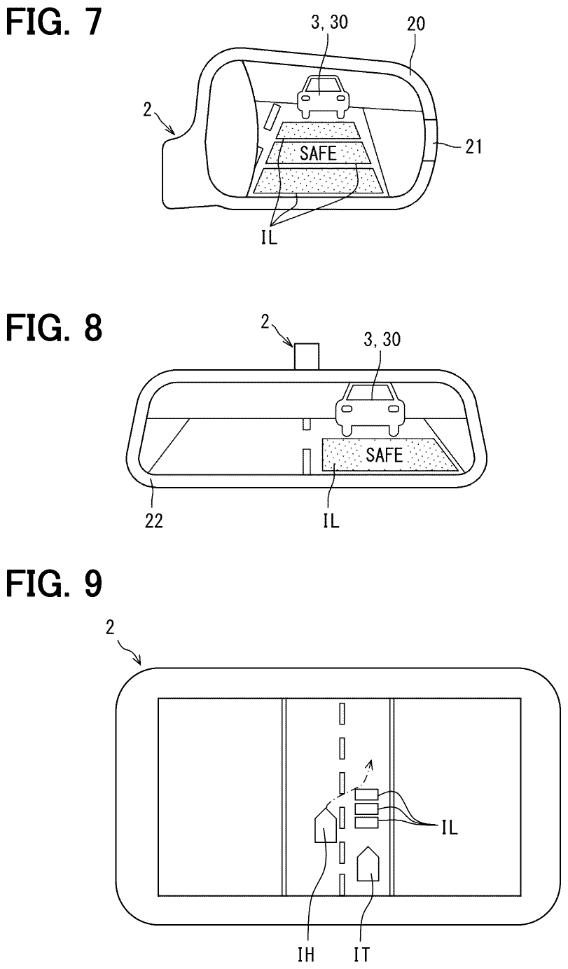

In S160, in response to the entry behavior Ae, the control block 120 may perform notification control to notify the host occupant in the host vehicle 2 of the continuation state of the entry behavior Ae from the start to the end in a manner recognizable by the host occupant in the host vehicle 2. As shown in FIG. 7, the blinking of the direction indicator 21 on the target lane 900t side attached to the side mirror 20 that reflects the target vehicle 30 outside the host vehicle 2 may be controlled by a light-emitting actuator as the actuator system 4, thereby notifying the continuation state of the entry behavior Ae. The flashing speed of the direction indicator 21 for notifying such a continuation state may be controlled to be slower than the normal speed when turning right or left in the host vehicle 2.

In S160, in response to the entry behavior Ae, the control block 120 may perform notification control to notify the host occupant in the host vehicle 2 of the relative positional relationship of the target vehicle 30 with respect to the inter-vehicle distance Lt, which is required behind the entry space 900ts, in a manner that is recognizable by the host occupant in the host vehicle 2. An inter-vehicle distance image IL for allowing the host occupant to recognize the required minimum safe inter-vehicle distance Lt (see FIG. 6) behind the entry space 900ts may be displayed on the electronic side mirror 20 that reflects the target vehicle 30 outside the host vehicle 2, as shown in FIG. 7, by control of the visual information presentation system 8a. As shown in FIG. 8, the inter-vehicle distance image IL may be displayed on an electronic rearview mirror 22 that shows the target vehicle 30 from within the host vehicle 2 under the control of visual information presentation system 8a. As shown in FIG. 9, by controlling the visual information presentation system 8a, the inter-vehicle distance image IL may be simulated and displayed on a monitor unit or navigation unit in the host vehicle 2, together with a host vehicle image IH simulating the host vehicle 2 and a target vehicle image IT simulating the target vehicle 30.

In either case, the control for notifying the relative positional relationship may be started from S140 or S150 prior to S160. After the execution of above-described S160 is completed, the current flow ends.

As shown in FIG. 4, when a negative determination is made in S130, the current flow proceeds to S170. In S170, the control block 120 controls the host vehicle 2 to perform the entry behavior Ae into the target lane 900t when no target vehicle 30 that is predicted to interact with the host vehicle 2 exists. After S170 is completed, the current flow also ends.

### Effects

The operation and effects of the present embodiment will be described below.

In the present embodiment, the deceleration of the target vehicle 30 is sensed. The target vehicle travels on rear side of the host vehicle 2 in the target lane 900t to which the host vehicle 2 is scheduled to make a lane change. In the present embodiment, the yielding behavior Ag of target vehicle 30 is monitored when the deceleration of target vehicle is sensed. The yielding behavior is a behavior of the target vehicle 30 for yielding the entry space 900ts of the target lane 900t, which corresponds to the lane change destination, to the host vehicle 2. This configuration enables quick determination for the target vehicle 30 that makes a deceleration in the target lane 900t and intends to yield the entry space 900ts to the host vehicle. Therefore, when the entry behavior Ae of the host vehicle 2 toward the entry space 900ts located ahead of the target vehicle 30, for which the yielding behavior Ag has been confirmed, is made by the host vehicle, safety and security can be secured between the host vehicle 2 and the target vehicle 30 traveling in the target lane 900t.

In the present embodiment, direct notification of yielding behavior Ag from the target vehicle 30 whose deceleration has been sensed is monitored. Thus, the target vehicle 30 intending to yield the entry space 900ts to the host vehicle can be determined in early stage with improved accuracy. Therefore, it is possible to increase the reliability of the effect of ensuring safety and security in the host vehicle 2.

According to the present embodiment, the indirect expression of intention to make the yielding behavior Ag by the target occupant of the target vehicle 30 whose deceleration has been sensed is monitored. Thus, the target vehicle 30 intending to yield the entry space 900ts to the host vehicle can be predicted and determined in early stage. Therefore, it is possible to promptly improve effect of ensuring safety and security for the host vehicle 2.

According to the present embodiment, direct yielding behavior Ag of the target vehicle 30 is monitored. The yielding behavior is a behavior of the target vehicle 30, whose deceleration is sensed, travels slower than the speed limit of the target lane 900t. Thus, the target vehicle 30 intending to yield the entry space 900ts to the host vehicle can be determined in early stage with high accuracy. Therefore, it is possible to increase the reliability of the effect of ensuring safety and security in the host vehicle 2.

According to the present embodiment, the entry behavior Ae is controlled and the host vehicle 2 is notified of the start of entry behavior Ae. This allows the host occupant, who can recognize the start of entry behavior Ae in the host vehicle 2 by the notification, to feel reassured that the lane change is safe since the yielding behavior Ag is made by the target vehicle 30.

According to the present embodiment, in conjunction with controlling the entry behavior Ae, in the host vehicle 2, the blinking speed of direction indicator 21 attached to the mirror 20 reflecting the target vehicle 30 is controlled to be slower than the normal speed. According to this configuration, the host occupant who can recognize the target vehicle 30 reflected in the mirror 20 of the host vehicle 2 can reduce the anxiety felt by the automatic lane change even when the target vehicle 30 is making the yielding behavior Ag by the slow flashing of the direction indicator 21.

According to the present embodiment, the relative positional relationship of the target vehicle 30 with respect to the inter-vehicle distance Lt required behind the entry space 900ts is displayed to the host occupant. This configuration enables the host occupant of the host vehicle 2 to reduce the anxiety felt for the automatic lane changes even when the target vehicle 30 is performing the yielding behavior Ag, by recognizing the relative positional relationship with respect to the required inter-vehicle distance Lt.

According to the present embodiment, the inter-vehicle distance image IL for allowing the host occupant to recognize the inter-vehicle distance Lt required behind the entry space 900ts may be displayed on the mirrors 20, 22 in the host vehicle 2 that reflect the target vehicle 30. In this case, the host occupant who can recognize the target vehicle 30 reflected in the mirrors 20, 22 of the host vehicle 2 can reduce the anxiety felt for the automatic lane changes even when the target vehicle 30 is making the yielding behavior Ag, by recognizing the position of the target vehicle 30 and the inter-vehicle distance image IL.

According to the present embodiment, the inter-vehicle distance image IL for allowing the host occupant to recognize the inter-vehicle distance Lt required behind the entry space 900ts may be displayed together with the images IH, IT that resemble respective vehicles 2, 30. In this case, the host occupant of the host vehicle 2 can reduce the anxiety felt for the automatic lane change even when the target vehicle 30 is making the yielding behavior, by recognizing the positions of images IH, IT corresponding to respective vehicles 2, 30 and the inter-vehicle distance image IL.

### Other Embodiments

Although one embodiment has been described above, the present disclosure is not to be construed as being limited to the embodiment of the description, and can be applied to various embodiments within the scope not departing from the spirit of the present disclosure.

In another modification, a dedicated computer constituting the driving assistance system 1 may include at least one of a digital circuit or an analog circuit, as a processor. The digital circuit is at least one type of, for example, an application specific integrated circuit (ASIC), a field programmable gate array (FPGA), a system on a chip (SOC), a programmable gate array (PGA), a complex programmable logic device (CPLD), and the like. Such a digital circuit may also include a memory in which a program is stored.

In S160 of the driving assistance flow according to a modified example, the notification control for notifying the start of entry behavior Ae may be skipped. In S160 of the driving assistance flow according to a modified example, the notification control for notifying the occupant of the continuation state of entry behavior Ae may be skipped. In S160 of the driving assistance flow according to a modified example, the notification control for notifying the relative positional relationship of the target vehicle 30 with respect to the inter-vehicle distance Lt required behind the entry space 900ts may be skipped.

In a modified example, the operator who manually drives the host vehicle 2 to which the driving assistance system 1 is applied may be a remote operator who remotely controls the driving of the host vehicle 2 from a center located outside of the host vehicle. In a modified example, the driving assistance system 1 may be implemented in the automatic driving tasks, that is, driving assistance tasks that assist the operator in manual driving operations do not exist.

What is claimed is:

1. A driving assistance system that assists a driving of a host vehicle, the driving assistance system comprising:
at least one processor with a memory storing computer program code, wherein the at least one processor with the memory is configured to cause the driving assistance system to:
schedule a lane change of the host vehicle;
sense a deceleration of a target vehicle traveling on a rear side of the host vehicle in a target lane, the target lane being a driving lane toward which the host vehicle plans to make the lane change;
monitor a yielding behavior of the target vehicle when a deceleration of the target vehicle is sensed, the yielding behavior being a behavior in which the target vehicle yields an entry space of the target lane as a lane change destination to the host vehicle; and
control an entry behavior of the host vehicle, the entry behavior being a behavior in which the host vehicle moves to the entry space located on a front side of the target vehicle by which the yielding behavior is made.

2. The driving assistance system according to claim 1, wherein
the at least one processor is configured to monitor the yielding behavior of the target vehicle by monitoring a notification of the yielding behavior from the target vehicle for which the deceleration is sensed.

3. The driving assistance system according to claim 1, wherein
the at least one processor is configured to monitor the yielding behavior of the target vehicle by monitoring an indication made by an occupant of the target vehicle for which the deceleration is sensed, and
the indication indicates an intention to perform the yielding behavior.

4. The driving assistance system according to claim 1, wherein
the at least one processor is configured to monitor the yielding behavior of the target vehicle by monitoring whether the target vehicle, for which the deceleration is sensed, travels at a speed lower than a speed limit of the target lane.

5. The driving assistance system according to claim 1, wherein
the at least one processor is configured to notify a start of the entry behavior of the host vehicle in a manner recognizable by an occupant of the host vehicle during controlling of the entry behavior of the host vehicle.

6. The driving assistance system according to claim 1, wherein
the at least one processor is configured to control a blinking rate of a direction indicator attached to a mirror of the host vehicle, in which the target vehicle is displayed, to a rate slower than a preset normal rate during controlling of the entry behavior of the host vehicle.

7. The driving assistance system according to claim 1, wherein
the at least one processor is configured to display a relative positional relationship of the target vehicle relative to an inter-vehicle distance required behind the entry space in a manner recognizable by an occupant of the host vehicle.

8. The driving assistance system according to claim 7, wherein
the at least one processor is configured to display, on a mirror disposed in the host vehicle, the relative positional relationship by displaying an inter-vehicle distance image indicating the inter-vehicle distance in a manner recognizable by the occupant of the host vehicle, and
the mirror displays the target vehicle in addition to the inter-vehicle distance required behind the entry space.

9. The driving assistance system according to claim 7, wherein
the at least one processor is configured to display the relative positional relationship by displaying a host vehicle image simulating the host vehicle and a target vehicle image simulating the target vehicle, together with an inter-vehicle distance image indicating the inter-vehicle distance required behind the entry space, in a manner recognizable by the occupant of the host vehicle.

10. A driving assistance method executed by at least one processor to assist a driving of a host vehicle, the driving assistance method comprising:
scheduling a lane change of the host vehicle;
sensing a deceleration of a target vehicle traveling on a rear side of the host vehicle in a target lane, the target lane being a driving lane toward which the host vehicle plans to make the lane change;
monitoring a yielding behavior of the target vehicle when a deceleration of the target vehicle is sensed, the yielding behavior being a behavior in which the target vehicle yields an entry space of the target lane as a lane change destination to the host vehicle; and
controlling an entry behavior of the host vehicle, the entry behavior being a behavior in which the host vehicle moves to the entry space located on a front side of the target vehicle by which the yielding behavior is made.

11. A computer-readable non-transitory storage medium storing a driving assistance program for assisting a driving of a host vehicle, the driving assistance program comprising instructions for causing at least one processor to:
schedule a lane change of the host vehicle;
sense a deceleration of a target vehicle traveling on a rear side of the host vehicle in a target lane, the target lane being a driving lane toward which the host vehicle plans to make the lane change;
monitor a yielding behavior of the target vehicle when a deceleration of the target vehicle is sensed, the yielding behavior being a behavior in which the target vehicle yields an entry space of the target lane as a lane change destination to the host vehicle; and
control an entry behavior of the host vehicle, the entry behavior being a behavior in which the host vehicle moves to the entry space located on a front side of the target vehicle by which the yielding behavior is made.
